(19) United States
(12) Patent Application Publication
(10) Pub. No.: US 2012/0275805 A1
(43) Pub. Date: Nov. 1, 2012

(54) Powder Spray System For Printing

(75) Inventor: Hisao Nagai, Kyoto-Shi (JP)

(73) Assignee: COSMOTECH CO., LTD., Kyoto-shi, Kyoto (JP)

(21) Appl. No.: 13/384,892

(22) PCT Filed: Aug. 10, 2010
(86) PCT No.: PCT/JP2010/063560

§ 371 Date: Jun. 1, 2012

(30) Foreign Application Priority Data
Sep. 14, 2009 (JP) 2009-211782

(51) Int. Cl. G03G 15/00

(52) U.S. Cl. 399/44; 399/341

(57) ABSTRACT

A powder spray system for printing 10 is an apparatus for spraying an offset-preventing powder 3 on the surface of a piece of printed paper 1 while the paper was moving. The powder spray system for printing 10 includes a printed-paper charger 11 for positively or negatively charging the paper 1, a powder charger 12 for electrically charging the powder 3 with an opposite polarity to that of the charged paper 1, a powder spraying device 13 for spraying the charged powder 3 on the paper 1 at a downstream of the printed paper charger 11 in the moving direction of the paper 1, a humidity measuring device 14 for measuring humidity in a space around the moving paper 1, and a controller 15 for controlling at least one of a voltage for charging the paper 1 in the printed paper charger 11 and a voltage for charging the powder 3 in the powder charger 12 depending on the measured humidity. The powder spray system 10 for printing can suppress variations in the adhesion amount of the powder 3 caused by the difference in humidity or the electric charging of the powder-sprayed paper.

### TECHNICAL FIELD

The present invention relates to a system for spraying, on a piece of printed paper discharged from a printer, a powder for preventing the offset of undried ink when stacking the paper.

### BACKGROUND ART

In order to prevent offset on freshly printed paper, powder spray systems for printing which spray powder on the surface of printed paper have been conventionally used. Powder is sprayed on the surface of printed paper while the printed paper is moved at high speed before being stacked. So, the powder disperses due to air currents generated by the movement of the paper. As a result, some problems arise, such as decrease in the settling efficiency of the powder on the paper surface, contamination of the printer, and deterioration of the work environment due to the dispersion to the surrounding environment.

Patent Documents 1 to 3 teach a technique in which printed paper is positively or negatively charged, and then an oppositely charged powder is sprayed on the surface of the paper. Such a technique allows the powder to electrically adhere to the surface of the paper more easily so that the adhesion efficiency of the powder is increased. Also, the contamination of the printer due to the powder can be suppressed. Moreover, the electric charge of the paper and that of the powder are electrically neutralized. The charging of the paper is performed by disposing a discharge electrode and an earth electrode with a paper pathway interposed therebetween, and applying a high voltage between the two electrodes. The charging of the powder is performed by disposing a discharge electrode and an earth electrode with a pathway of the air carrying the powder interposed therebetween in the nozzle, and applying a high voltage between the two electrodes.

### BACKGROUND ART DOCUMENT

### Patent Document

[Patent Document 1] JP-A 58-071165 (claim 5, from line 18 on the eighths column to line 7 on the eleventh column, and FIG. 3)
[Patent Document 2] JP-A 62-068754 (Claims, from line 5 on the third column to line 11 on the fourth column, and Figures)
[Patent Document 3] JP-A 2002-522277 (Paragraph [0007])

### SUMMARY OF THE INVENTION

### Problems to be Solved by the Invention

In the devices disclosed in Patent Documents 1 to 3, even if the level of the voltage supplied to the paper is the same as that supplied to the powder, the adhesion efficiency of the powder to the surface of the paper varies depending on the differences in such conditions as date and time to use the device, and use environment. If the adhesion efficiency of the powder decreases, due to the powder having failed to adhere to the surface of the paper, the contamination of the printer becomes worse, or the work environment further deteriorates. Moreover, a vicious circle occurs in which, for making up for the decrease in the adhesion efficiency, a larger amount of the powder needs to be sprayed to ensure adhesion of a predetermined amount of the powder to the surface of the paper, which in turn increases the amount of powder failing to adhere to the surface of the paper. Furthermore, the powder-sprayed paper is found to remain electrically charged in some cases depending on the conditions.

The problem to be solved by the invention is to provide a powder spray system for printing capable of reducing variations in the adhesion efficiency of the powder caused by differences in such conditions as date and time or environment of use, and preventing the powder-sprayed paper from remaining electrically charged.

### Means for Solving the Problem

The present inventor made investigations to find the cause of the variation in the adhesion efficiency of the powder and the factor that determines whether the paper will be charged or not after the powder is sprayed. The investigations revealed that the charge quantity of paper or powder changes depending on humidity, even if the same voltage is applied to the paper and the powder. And such changes disrupt the equilibrium between the charge quantity of the paper and that of the powder. As a result, the powder becomes less likely to electrically adhere to the surface of the paper, or the powder-sprayed paper remains electrically charged. Based on these findings, the present invention has been completed.

Namely, the powder spray system for printing according to the present invention which has been devised to solve the aforementioned problem is a device to spray an offset-preventing powder on the surface of a piece of printed paper while the printed paper is moving. The powder spray system includes:

a) a printed paper charger for electrically positively or negatively charging the paper;

b) a powder charger for electrically charging the powder with an opposite polarity to that of the charged paper;

c) a powder spraying device for spraying the charged powder on the paper at a downstream of the printed paper charger in the moving direction of the paper;

d) a humidity measuring device for measuring humidity in a space around the moving paper; and

e) a controller for controlling at least one of a voltage for charging the paper in the printed paper charger and a voltage for charging the powder in the powder charger, depending on the measured humidity.

Generally, under the same conditions except for the humidity, a higher humidity leads to a lower charge quantity of the paper or powder. Since paper and powder have different degree of humidity-derived reduction in the charge quantity from one another, even if the charge quantity of paper and that of powder are controlled to be at equilibrium at a certain humidity, the equilibrium will be disrupted when the humidity changes. Taking this into consideration, the powder spray system for printing according to the present invention controls the charge quantities of the paper and/or powder by adjusting at least one of the voltage used for charging the paper in the printed paper charger and the voltage used for charging the powder in the powder charger, depending on the humidity in a space around the paper. Controlling the charge quantity of at least one of the paper and the powder as mentioned earlier leads to the equilibrium between the charge quantity of the paper and that of the powder. As a result, the powder becomes more likely to electrically adhere to the surface of the paper so that the adhesion efficiency can be enhanced. Furthermore, the powder-sprayed paper can be prevented from remaining electrically charged. The control of the voltage depending on the humidity can be performed based on the optimum relationship between the humidity and the voltage previously obtained by experiments.

Preferably, the printed paper charger is provided with a plate-like ground electrode having a through hole, the ground electrode facing the surface of the moving paper, and a needle-like electrode passing through the through hole in such a manner that a tip end thereof is projected to the paper side from the ground electrode.

If the tip end of the needle-like electrode is projected to the paper side from the ground electrode as mentioned above, ions moving to the surface of the paper, among ions generated by application of high voltages between the needle-like electrode and the ground electrode, can be prevented from being blocked by the ground electrode.

Preferably, the powder charger is provided with a powder-charger electrode, and a powder supplier for supplying the powder to the powder-charger electrode in such a manner that the powder directly makes contact with the powder-charger electrode.

If the powder is directly made into contact with the powder-charger electrode, the powder can be efficiently charged. Further, since the powder can be charged without using electric discharge, risks of explosions derived from discharge in a dusty environment can be avoided, leading to safe handling of the powder.

### Effects of the Invention

The powder spray system for printing according to the present invention controls at least one of the voltage used for charging the paper in the printed paper charger and the voltage used for charging the powder in the powder charger, depending on the humidity measured by the humidity measuring device. Thus, the powder spray system can suppress variations in the amount of the adhered powder caused by differences in the humidity. The powder spray system can also prevent contamination of the printer or deterioration of the work environment due to the dispersion of the powder over the surrounding area, which occurs especially when the adhesion efficiency decreases. Moreover, the powder spray system can prevent the powder-sprayed paper from remaining electrically charged.

### BRIEF DESCRIPTION OF THE DRAWINGS

FIGS. 1A and 1B are schematic structural diagrams showing an example of a printer including the powder spray system for printing according to the present invention.

FIG. 2 is a schematic structural diagram showing one embodiment of the powder spray system for printing according to the present invention.

FIG. 3 is an enlarged view of a printed paper charging unit in the powder spray system for printing of the present embodiment.

FIG. 4 is an enlarged view of a powder charging unit and a powder spraying unit in the powder spray system for printing of the present embodiment.

FIG. 5 is a graph showing measurement results of the relationship between the voltage applied to paper and the charge quantity of powder.

FIG. 6 is a graph showing measurement results of the relationship between the humidity and the charge quantity of powder.

FIGS. 7A and 7B are micrographs showing the surfaces of powder-sprayed paper in the present example (FIG. 7A) and comparative example (FIG. 7B).

### MODE FOR CARRYING OUT THE INVENTION

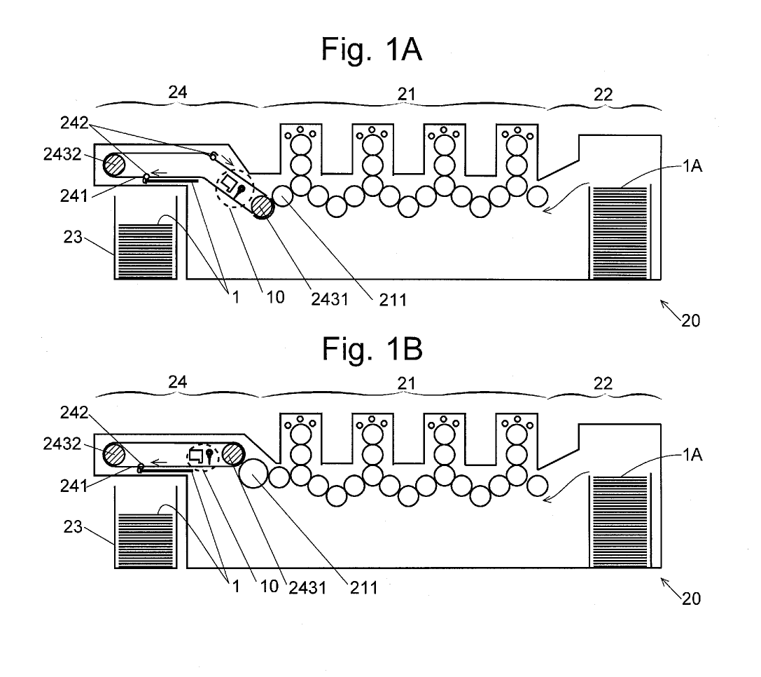

The following description will discuss one embodiment of the powder spray system for printing according to the present invention with reference to FIGS. 1-7.

### Embodiment

A powder spray system for printing 10 of the present example is used in combination with a printer. FIGS. 1A and 1B show an example of a printer including the powder spray system for printing according to the present invention. The printer 20 includes a printing unit 21, a paper feeder 22 to supply the printing unit 21 with paper 1A for printing, a stacker 23 for holding a stack of printed paper 1 delivered from the printing unit 21, and a delivery unit 24 for delivering the printed paper 1 from the printing unit 21 to the stacker 23.

The delivery unit 24 includes an endless chain 241 and a gripper 242 attached to the endless chain 241. The endless chain 241 is hung on a first chain guide 2431 and a second chain guide 2432, and a part of the endless chain 241 is located directly above the stacker 23. The first chain guide 2431 faces a guide roller 211 provided in the printing unit 21. The delivery unit 24 of this type is a known product as disclosed in, for example, JP-A 7-267452 or JP-A 2001-199044.

The delivery unit 24 operates as follows: The gripper 242 moves cyclically accompanying rotations of the first chain guide 2431 and the second chain guide 2432. The gripper 242 grips the paper 1 fed from the guide roller 211 to move the paper 1 to directly above the stacker 23 and releases it. Accordingly, the paper 1 is stacked in the stacker 23. The gripper 242 having released the paper 1 cyclically moves to return to a neighborhood of the guide roller 211, and grips the paper 1 again. The gripper 242 repeatedly transfers the paper 1 from the printing unit 21 to the stacker 23 in the aforementioned manner.

The powder spray system for printing 10 is provided in the delivery unit 24 as shown in FIGS. 1A and 1B. Examples of the location of the powder spray system for printing 10 in the delivery unit 24 are hereinafter described. In the example shown in FIG. 1A, the first chain guide 2431 is located at a position lower than the second chain guide 2432 so as to move the paper 1 up to a position higher than the stacker 23. The endless chain 241 extends obliquely upward between the first chain guide 2431 and a position on the way to the second chain guide 2432. In this example, the powder spray system for printing 10 is disposed at a position between the first chain guide and the second chain guide 2432 where the endless chain 241 extends obliquely upward. In the example shown in FIG. 1B, the guide roller 211 in the printing unit 21 is provided at a position higher than the position in the example shown in FIG. 1A so as to move the paper 1 up to a position higher than the stacker 23. As a result, the entirety of the endless chain 241 is disposed almost horizontally. In this example, the powder spray system for printing 10 is disposed between the first chain guide 2431 and the second chain guide 2432.

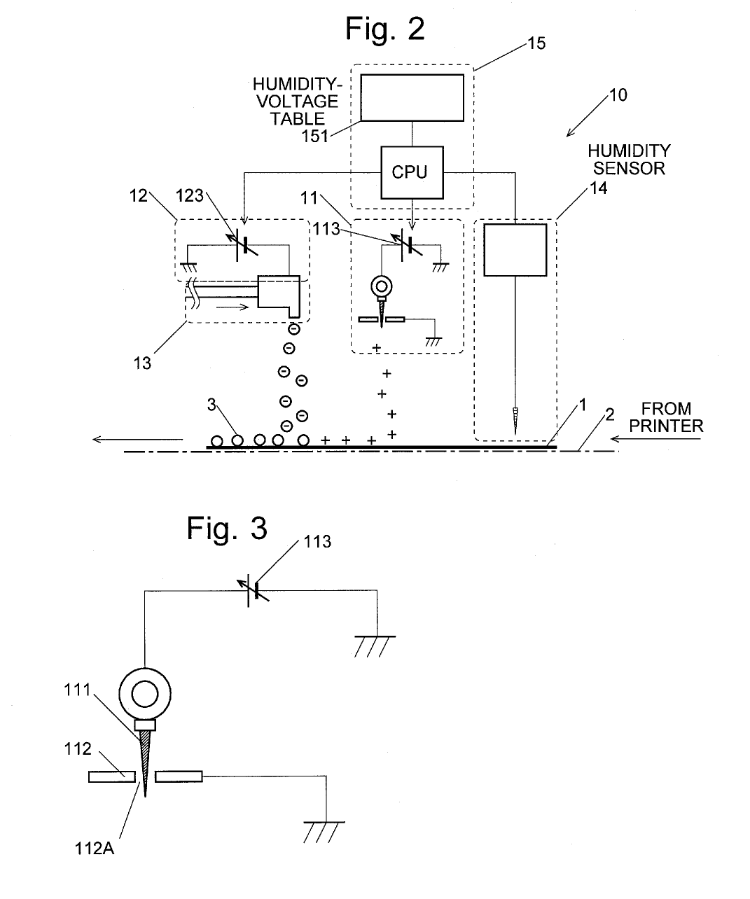

The following will discuss the details of the powder spray system for printing 10 with reference to FIGS. 2-4. The powder spray system for printing 10 sprays powder 3 on the surface of the paper 1 while the paper 1 discharged from the printer is passed one by one through a delivery route 2 by the delivery unit 24. The paper 1 with the powder 3 sprayed thereon passes through the delivery route 2, and thereafter is stacked in the stacker 23. In this process, the powder 3 on the surface of the paper prevents the surface ink from transferring to the rear surface of the upper paper. Examples of the powder 3 include starch powder and starch granules with coating.

The structure of the powder spray system for printing 10 is hereinafter described. The powder spray system for printing 10 includes a printed-paper charging unit 11, a powder charging unit 12, a powder spraying unit 13, a humidity sensor 14, and a controller 15.

As shown in an enlarged view in FIG. 3, the printed-paper charging unit 11 includes a needle-like electrode 111, and a plate-like ground electrode 112 disposed approximately in parallel with the paper 1 passing through the delivery route 2. The ground electrode 112 has a through hole 112A. The needle-like electrode 111 passes through the through hole 112A in such a manner that a tip end thereof is projected to the paper 1 side from the ground electrode 112. The needle-like electrode is connected to an anode of a first high-voltage variable direct-current source 113 capable of changing the output voltage in a range of 0 V to several tens kV.

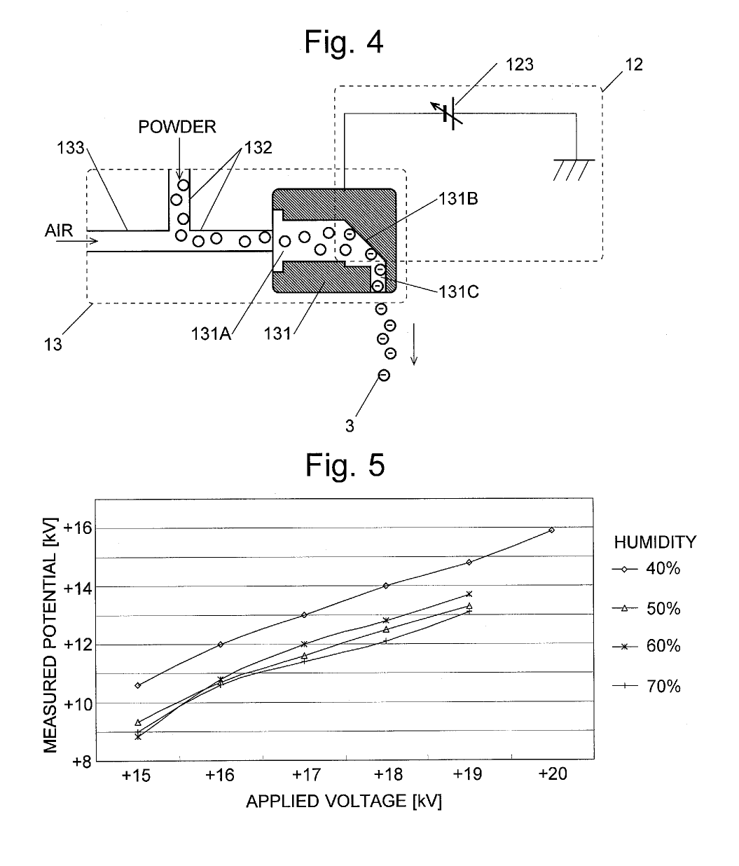

The powder charging unit 12 and the powder spraying unit 13 have the structures shown in FIG. 4.

First, the powder spraying unit 13 is described. The powder spraying unit 13 includes a metal nozzle 131 for spraying the powder 3 on the surface of the paper 1, a powder supplying tube 132 for supplying the powder 3 to the nozzle 131, and an air supplying tube 133 for supplying air to the powder supplying tube 132 to mix the powder 3 with the air.

The powder charging unit 12 includes the nozzle 131 and a second high-voltage variable direct-current source 123 whose cathode is connected to the nozzle 131. The nozzle 131 encloses a powder introducing tube 131A connected to the powder supplying tube 132 and extending on an extension line of the powder supplying tuber 132, a powder contacting wall (powder-charger electrode) 131B provided at an angle of 45° with respect to an extension direction of the powder supplying tube 131A, and a powder spraying tube 131C provided at an angle of 90° with respect to an extension direction of the powder supplying tube 131A and extending in a direction perpendicular to the paper 1. Since the powder contacting wall 131B is a part of the metal body configuring the nozzle 131, a negative potential with respect to the ground potential is applied to it by the second high-voltage variable direct-current source 123. Thus, the nozzle 131 is not only a component of the powder spraying unit 13 but also a component of the powder charging unit 12.

As shown in FIG. 2, the intersection of an extension line of the powder spraying tube 131C and the paper 1 is located downstream of the moving direction of the paper 1 from the intersection of an extension line of the needle-like electrode 111 of the printed paper charging unit 11 and the paper 1. A humidity sensor 14 measures the humidity in the vicinity of the paper 1 at a position upstream of the above two intersections in the moving direction of the paper 1.

Upon receiving an input of the humidity measured with the humidity sensor 14, the controller 15 controls output voltages of the first high-voltage variable direct-current source 113 and the second high-voltage variable direct-current source 123 depending on the inputted humidity. An arithmetic device such as a personal computer may be employed as the controller 15. The controller 15 includes a humidity-voltage table 151 which records the correspondence relationship of the measured humidity and the voltages to be outputted to the first high-voltage variable direct-current source 113 and the second high-voltage variable direct-current source 123. The data of the humidity-voltage table 151 should be obtained by a preparatory experiment. Memory units (memory, hard disc, and the like) of computers may be used as the humidity-voltage table 151.

An operation of the powder spraying unit for printing 10 is hereinafter described. The following description is initially focused on (1) the basic operations of the printed-paper charging unit 11, the powder charging unit 12, and the powder spraying unit 13, and then (2) the control of the charge quantity depending on humidity.

### (1) Basic Operations of Printed-Paper Charging Unit 11, Powder Charging Unit 12, and Powder Spraying Unit 13

As mentioned earlier, while the paper 1 discharged from the printer passes through the delivery route 2, high voltage is applied between the needle-like electrode 111 and the ground electrode 112 by the first high-voltage variable direct-current source 113. The value of the voltage to be applied will be described later. Application of the high voltage generates corona discharge in the vicinity of the tip of the needle-like electrode 111. The corona discharge causes ionization of gas molecules and produces cations. Adhesion of the thus-generated cations to the paper 1 positively charges the paper 1. The reason for using corona discharge for generating ions in the present embodiment is that, as compared to other types of discharge, corona discharge is smaller in the fluctuation of the discharge current when a constant voltage is applied, and due to this characteristic of corona discharge, the amount of ion generation can be easily controlled through the applied voltage. Moreover, the tip end of the needle-like electrode 111 is projected to the paper 1 side from the ground electrode 112 in the present embodiment. Therefore, the cations generated in the vicinity of the tip end of the needle-like electrode 111 reach the paper 1 without being blocked by the ground electrode 112.

As shown in FIG. 4, in the powder charging unit 12 and the powder spraying unit 13, the powder 3 is supplied from the powder supplying tube 132 to the nozzle 131. Simultaneously, air is supplied from the air supplying tube 133 to the powder supplying tube 132. As a result, a mixture of the powder 3 and air is introduced into the nozzle 131. At the same time, high voltage is applied to the nozzle 131 by the second high-voltage variable direct-current source 123. The mixture of the powder and air passes through the powder introducing tube 131A and makes contact with the powder contacting wall 131B in the nozzle 131. In this process, a negative potential is applied to the powder contacting wall 131B. Therefore, upon contacting the powder contacting wall 131B, the powder 3 becomes negatively charged.

The thus negatively charged powder 3 is dropped from the powder spraying tube 131C toward the paper 1, and adheres to the surface of the paper 1. Since the dropped powder 3 is negatively charged, the powder 3 is electrically attracted to the positively charged paper 1. Therefore, the powder 3 hardly disperses around. As a result, contamination of the surrounding areas caused by the powder 3 or variation in the amount of the powder 3 arriving at the paper 1 can be avoided.

### (2) Control of Charge Quantity Depending on Humidity

As explained in (1), the electric charges given to the paper 1 and the powder 3 are electrically neutralized on the surface of the paper 1. However, if the positive charge quantity given to the paper 1 and the negative charge quantity given to the powder 3 are not balanced, either negative or positive charges will remain on the paper 1 with the powder 3 sprayed thereon. A reason for the imbalance between the positive and negative charges is the change in the charge quantities of the paper 1 and the powder 3 due to humidity.

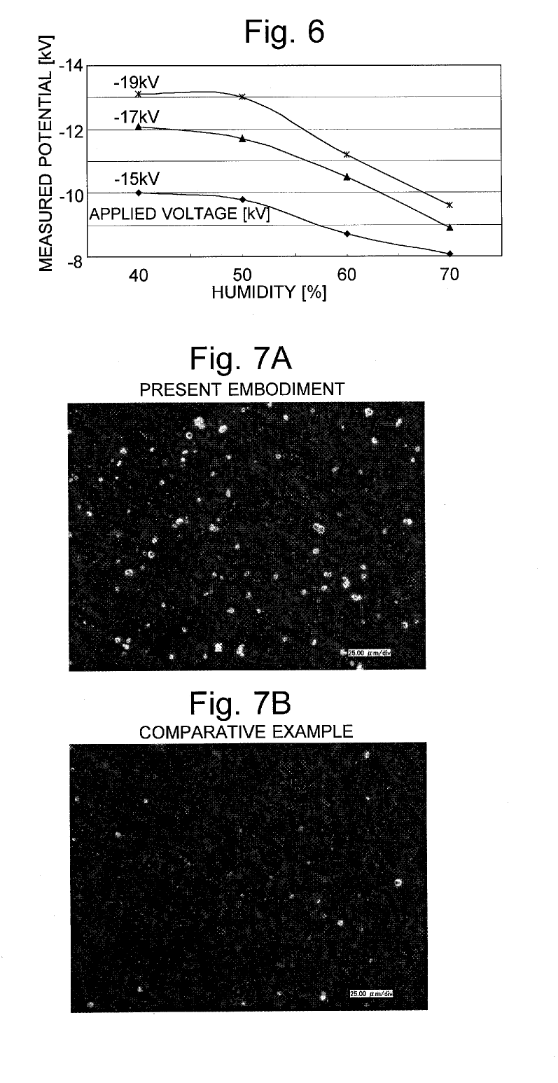

The results of two experiments using the powder spray system for printing 10 of the present embodiment are hereinafter described by means of FIGS. 5 and 6. One experiment (Experiment 1) was conducted to determine the relationship between the charge quantity of the paper and the humidity, while the other experiment (Experiment 2) was conducted to determine the relationship between the charge quantity of the powder and the humidity. In Experiment 1, the change in the electric potential of the paper was measured while changing two parameters: (i) the positive voltage applied to the paper by the printed-paper charging unit 11, and (ii) the humidity in the laboratory room in which the powder spray system for printing 10 was placed. In Experiment 1, no powder was sprayed on the paper. In Experiment 2, the change in the electric potential of the powder-sprayed paper was measured while changing two parameters: (i) the negative voltage applied to the powder by the powder charging unit 12, and (ii) the humidity in the laboratory room in which the powder spray system for printing 10 was placed. In Experiment 2, no voltage was applied to the paper by the printed-paper charging unit 11. Accordingly, it can be said that the change in the electric potential of the paper reflected the change in the charge quantity of the powder in Experiment 2. In both Experiments 1 and 2, the same kinds of paper and powder were used, and the same amount of powder was sprayed.

FIG. 5 is a graph showing the change in the electric potential of the paper caused by changing of the voltage applied by the printed-paper charging unit 11 to the paper in Experiment 1, where the humidity in the laboratory room was set at 40%, 50%, 60%, or 70%. The graph shows that an increase in the humidity tends to reduce the electric potential of the paper, i.e., the charge quantity of the paper. As described earlier, by adjusting the voltage applied to the paper, the electric potential of the paper, i.e., the charge quantity of the paper can be controlled.

FIG. 6 is a graph showing the change in the electric potential of the paper caused by changing of the humidity in the laboratory room in Experiment 2, where voltage applied to the powder by the powder charging unit 12 was set at −15 kV, −17 kV, and −19 kV. The graph shows that an increase in the humidity tends to reduce the absolute value of the electric potential of the paper with the charged powder sprayed thereon, i.e., the charge quantity of the powder.

It has been thus proved that the charge quantity of the paper 1 and that of the powder 3 change depending on the humidity. Then, data (data to be stored in a humidity-voltage table 151) to determine the voltage of the printed-paper charging unit 11 and the voltage of the powder charging unit 12 at each humidity are prepared so that the charge quantity of the paper obtained in Experiment 1 and the charge quantity of the powder obtained in Experiment 2 are as equal as possible at each humidity. While the powder is sprayed, and the paper and the powder are electrically charged as described in (1), the humidity in the vicinity of the paper 1 is measured with the humidity sensor 14. At the same time, the controller 15 calculates set values of the output voltages of the first high-voltage variable direct-current source 113 and the second high-voltage variable direct-current source 123 appropriate for the measured humidity using the data stored in the humidity-voltage table 151, and thereby controls the two output voltages. In this manner, the positive charge quantity applied to the paper 1 and the negative charge quantity applied to the powder 3 are changed depending on the humidity so that the powder-sprayed paper 1 will be prevented from remaining electrically charged.

Meanwhile, in Experiments 1 and 2, the voltage applied to the paper with the printed-paper charging unit 11 and the voltage applied to the powder with the powder charging unit 12 were set within a range of 15 kV to 19 kV (15 kV to 20 kV for 40% humidity in Experiment 1) in absolute values. Actually, the charge quantity of the paper and the charge quantity of the powder can be equalized in a wider range of applied voltages. Since the charge quantity varies depending on the material of the powder and that of the paper, the data stored in the humidity-voltage table 151 should be prepared specifically for the actually-used powder and paper.

FIG. 7A is a micrograph showing the surface of the powder-sprayed paper obtained by spraying the powder with the powder spray system for printing 10 of the present embodiment while applying a voltage of +12.6 kV to the printed-paper charging unit 11 and a voltage of −11.0 kV to the powder charging unit 12. FIG. 7B is a micrograph showing, as a comparative example, the surface of the powder-sprayed paper obtained by spraying the powder without applying voltages to the printed-paper charging unit 11 and the powder charging unit 12. As indicated by those micrographs, a larger amount of powder particles, which appear in white in the micrographs, seems to adhere to the surface in the present example than the surface in the comparative example. Actual counting of easily visible particles having a diameter of 10 μm or more among the powder particles appearing in the micrographs revealed that the number of particles was 20 in comparative example, while the same number in the present example was a larger value of 91. The result demonstrates that adhesion of the powder to the surface of the paper is easier in the present embodiment, and thus contamination due to the powder around the paper hardly occurs.

The powder spray system for printing according to the present invention is not limited to the one described in the previous embodiment.

For example, in the above embodiment, both of the voltage between the needle-like electrode 111 and the ground electrode 112 and the voltage between the powder contacting wall 131B and the ground are controlled depending on the humidity. However, either one of the voltages may be controlled.

Moreover, in the above embodiment, the positive electrode of the first high-voltage variable direct-current source 113 is connected to the needle-like electrode 111, and the negative electrode of the second high-voltage variable direct-current source 123 was connected to the powder contacting wall 131. However, the negative electrode of the first high-voltage variable direct-current source 113 may be connected to the needle-like electrode 111, and the positive electrode of the second high-voltage variable direct-current source 123 may be connected to the powder contacting wall 131B. In this case, the paper 1 is negatively charged, and the powder 3 is positively charged.

### EXPLANATION OF NUMERALS

1 . . . Paper
2 . . . Delivery Route
3 . . . Powder
10 . . . Powder Spray System for Printing
11 . . . Printed-Paper Charging Unit
111 . . . Needle-Like Electrode
112 . . . Ground Electrode
112A . . . Through Hole
113 . . . First High-Voltage Variable Direct-Current Source
12 . . . Powder Charging Unit
123 . . . Second High-Voltage Variable Direct-Current Source
13 . . . Powder Spraying Unit
131 . . . Nozzle
131A . . . Powder Introducing Tube
131B . . . Powder Contacting Wall
131C . . . Powder Spraying Tube
132 . . . Powder Supplying Tube
133 . . . Air Supplying Tube
14 . . . Humidity Sensor
15 . . . Controller
151 . . . Humidity-Voltage Table
20 . . . Printing Machine
21 . . . Printing Unit
211 . . . Guide Roller
22 . . . Paper Feeder
23 . . . Stacker
24 . . . Delivery Unit
241 . . . Endless Chain
242 . . . Gripper
2431 . . . First Chain Guide
2432 . . . Second Chain Guide

1. A powder spray system for printing to spray an offset-preventing powder on a surface of a piece of printed paper while the paper is moving, comprising:
a) a printed paper charger for electrically positively or negatively charging the paper;
b) a powder charger for electrically charging the powder with an opposite polarity to that of the charged paper;
c) a powder spraying device for spraying the charged powder on the paper at a downstream of the printed paper charger in the moving direction of the paper;
d) a humidity measuring device for measuring humidity in a space around the moving paper; and
e) a controller for controlling at least one of a voltage for charging the paper in the printed paper charger and a voltage for charging the powder in the powder charger, depending on the measured humidity.

2. The powder spray system for printing according to claim 1,
wherein the printed paper charger comprises:
a plate-like ground electrode having a through hole, the ground electrode facing the surface of the moving paper; and
a needle-like electrode passing through the through hole in such a manner that a tip end thereof is projected to a paper side from the ground electrode.

3. The powder spray system for printing according to claim 1,
wherein the powder charger comprises:
a powder-charger electrode; and
a powder supplying device for supplying the powder to the powder-charger electrode in such a manner that the powder directly makes contact with the powder-charger electrode.

4. The powder spray system for printing according to claim 2,
wherein the powder charger comprises:
a powder-charger electrode; and
a powder supplying device for supplying the powder to the powder-charger electrode in such a manner that the powder directly makes contact with the powder-charger electrode.
